(19) United States
(12) Patent Application Publication
(10) Pub. No.: US 2013/0216761 A1
(43) Pub. Date: Aug. 22, 2013

(54) PACKAGING CEMENTITIOUS PRODUCTS

(71) Applicant: William Alexander James Sadler, Mitcham (AU)

(72) Inventor: William Alexander James Sadler, Mitcham (AU)

(73) Assignee: Sadler IP Pty Ltd, Mitcham, Victoria (AU)

(21) Appl. No.: 13/810,127

(22) PCT Filed: Jul. 14, 2010
(86) PCT No.: PCT/AU2010/000895

§ 371 Date: May 9, 2013

(51) Int. Cl. C04B 41/00

(52) U.S. Cl. CPC C04B 41/0018
USPC 428/69; 427/372.2; 427/294; 428/446

(57) ABSTRACT

The present invention provides a method of processing cementitious products to substantially reduce or eliminate efflorescence. The method includes applying a protective layer to at least one surface of a slab product at the time of pouring cementitious mix into a mould and retaining the protective layer in place. The protective layer is a relatively thin sheet of plastic material.

### FIELD OF THE INVENTION

The present invention relates generally to cementitious products.

### BACKGROUND AND PRIOR ART

Presently, the process of manufacturing cementitious products such as tiles in small individual moulds remains substantially the same as production methods that have been employed for the past 50 years and is still popular throughout the world.

However, over the past twenty years, the production of tiles has developed resulting in tiles with a greater contemporary appearance in response to the fashion and trends of modern architecture and interior design.

Presently, commercially available cementitious slab products are produced from a mix which typically comprises cement, silica sand, large (or coarse) aggregate pieces, a water reducing admixture and water. The large aggregate pieces are included to make up mass and may vary in size from approximately 3 mm to 10 mm or larger. Stone chips are often used as large aggregate pieces. The water reducing admixture may be a plasticizer based on Polycarboxylatic Ether Polymer.

The strength of material used in tile production has increased in relatively recent times, allowing tiles to be produced from a single large and thin slab, similar to marble or granite slabs, which can be cut to produce square or rectangular tiles of a desired size.

Large slabs are formed in individual moulds which are then subject to a vibration process. This causes the finest particles to move to the bottom of the mould. A slab takes the form or shape of the surface of the mould. This is known as “off-form” material.

Such production methods have allowed for greater flexibility in variation of sizes and thicknesses of square and/or rectangular tiles. Cutting tiles from a single slab allows for the production of square and/or rectangular tiles of differing sizes, which would previously have been produced in small individual moulds. Flexibility in production allows tiles to be made to a size at the request of a client without significant re-tooling or maintaining a large number of different mould sizes in stock. Additionally, precision machinery allows for a more accurate and superior finishing for the tiles.

In addition to the abovementioned advantages, cutting a large slab into smaller tiles takes advantage of the inherent natural aesthetic qualities of the large format slab. When separated, the smaller tiles have a unique appearance which increases the visual appeal of large surfaces such as walls and floors when covered with the smaller tiles

After the material is mixed it is placed into large moulds where the mix is vibrated into place. For mixes where fluid is added in order to activate the bonding process, the mix is poured into the mould and allowed to cure to a sufficient extent to allow the slab to be removed from the mould.

The moulds are generally stored in a location where the material is allowed to set and harden prior to cutting. The storage period for wet mixed slabs is approximately one to four weeks before the slab is sufficiently cured for cutting of the material.

For naturally cured large slabs, once hardened sufficiently they are de-moulded and stacked for curing. Curing may require up to 4 weeks depending on the method and effectiveness of the curing process.

Of course, the need to allow the slab material sufficient time to cure prior to the cutting process requires the poured slabs to be shifted from the pouring line to a storage area. Generally, the slabs rest on frames after removal from their mould and are packaged for curing. This requires an interruption to the manufacturing process and the provision of sufficient storage space to store the slabs for curing in addition to the manually intensive processes associated with the removal of the slabs from their moulds and placing into storage for curing.

Slabs are calibrated for thickness before being cut into tiles. Following cutting, tiles are “rectified” to produce more accurate sides, the edges of the tiles are chamfered or arrised to erase chipping damage that is usually caused during the cutting process. Individual tiles are then processed including cleaning, drying and packing before being dispatched for sale.

The cutting process and subsequent operations are commonly performed on a continuous automated production line.

As a result, cement or concrete tiles may be ordered and installed in a similar manner to marble, granite and/or porcelain tiles. Further, tiles processed in this manner generally result in a higher quality installation outcome.

However, present production methods of tiles have a number of significant problems.

For example, the processing (cutting, calibrating, arising and/or rectification) of a slab is generally effected by use of diamond cutting tools, such as cutting blades, calibrating tools etc.

When cutting a slab, which is a very hard material, the edges of the cut are subject to varying degrees of chipping and rough edges. Further, the slabs and/or tiles are liable to crack or break during the cutting and calibrating process. The stresses can cause chips and breakages, particularly at corners where the cementitious slab or the tiles are weakest. The chipping, cracking and/or breakages can result in wastage or the need to repair damaged material. This can be both costly and time consuming.

Another disadvantage is that the processing is difficult and requires care by skilled operators in order to ameliorate wastage due to chips, cracks and/or breakages. Such skilled operators are costly and the production of the tiles from the slab is time consuming and interrupts the production process.

Subsequent to the calibrating and cutting process, the slab products are generally stored again to fully cure which may require a further three to four weeks of storage in a controlled environment before dispatching the products to their installation destination. The further storage of slab products for final curing represents additional handling and storage costs.

Other disadvantages in present production techniques include the need for expensive equipment for cutting (including diamond tools and large capital equipment), large energy costs (for example, electricity) and a large amount of water, which is consumed during the processing of slabs into products. It is not unusual for a calibrating apparatus to cost $400,000 or more with a cutting line expected to cost approximately $700,000 to $1 million dollars.

The cutting and calibration processes also result in a large quantity of waste material, which is created when material is removed during the cutting and calibration processes. The waste must then be separated from the water used for the processing prior to re-use of that water. The separated waste material must be collected, treated and disposed of, which may be inconvenient and/or expensive. In this regard, the cost of a water filtration system is expected to be approximately $100,000 to $200,000. Further, the operational cost with respect to electrical energy consumption of all the equipment is generally significant as most of the equipment needs a multi-purpose power supply.

The cutting process can be particularly wasteful when cutting small tiles or mosaic pieces as the diamond cutting blade removes approximately 3 mm to 5 mm of material from each cut. When producing many tiles from slabs, the total volume of material removed during the cutting process is significant.

Typically, preparing a factory for production of slabs and tiles is an expensive undertaking requiring a great deal of planning, preparation, construction and installation time. A factory floor must be specially adapted in order to accommodate heavy purpose built equipment, with each plant requiring drainage systems and effluent tanks for collecting, separating and treating waste material from the water. In addition to all of the abovementioned disadvantages, the construction of a factory with special purpose drainage systems in itself represents a significant cost and hence an impediment to the establishment of a manufacturing facility.

An alternative product to slabs and tiles produced therefrom is natural stone material. However, natural stone material has many variables which are difficult to control. The stone material may be too soft, too hard, too porous or may have too many veins to be useful for a particular purpose. Furthermore, such materials may not be aesthetically appealing for a customer or suitable for a particular application.

An additional problem in current production methods is that the tiles (or the slab) are subject to efflorescence. Efflorescence has always been a problem with cementitious products. Efflorescence brings soluble salts and other water dispersible materials to the surface that are not commonly bound as part of the cement stone. Efflorescence is generally observed as a deposit of salts, usually white, formed on a surface, the substance having emerged in solution from within either concrete or masonry which have subsequently been precipitated by reaction, such as carbonation, or evaporation. While efflorescence does not compromise concrete's integrity, its effect on the aesthetic quality of products constitutes a costly problem for the industry.

There are two main types of efflorescence, primary efflorescence and secondary efflorescence. Primary and secondary efflorescence are distinguished mainly by time of occurrence. Primary efflorescence is caused by excess water during concrete fabrication, typically appearing during the first 48-72 hours.

Secondary efflorescence arises where water penetrates the surfaces and dissolves soluble calcium salts. The main chemical reaction is the same as that in primary efflorescence, conversion of calcium hydroxide to calcite. Secondary efflorescence originates from reaction in solution, usually caused by rain or condensation, and is thus of a more uneven nature, whereas primary efflorescence is caused by evaporation leaving behind the deposited salts.

Three conditions must be present for efflorescence to occur:
(1) presence of soluble salts;
(2) availability of water to carry the salts in solution; and
(3) a pathway for the solution's migration to the surface (and water evaporation).

The most common efflorescence salts include calcium carbonate, sodium sulphate, and potassium sulphate, the most prevalent and deleterious being calcium carbonate. During the cement hydration process, calcium hydroxide, Ca(OH)₂, which is slightly soluble in water, is formed. The Ca(OH)₂ dissolves and is carried to the concrete surface, where it reacts with carbon dioxide, CO₂, in the air to form calcium carbonate, CaCO₃, plus water:

Ca(OH)₂(dissolved)+CO(dissolved)→CaCO₃(solid)+H₂O(liquid)

The water evaporates, leaving insoluble CaCO₃ on the surface. In most cases, the residue cannot be simply rinsed off with plain water, its removal requiring the application of weak acid and/or abrasion. Efflorescence arising from sodium or potassium salts is water soluble and thus more easily removed.

The salts which can form a white, “fluffy” deposit or discolouration which can be cleaned off using a suitable agent such as phosphoric acid. The acid can be neutralised with a mild diluted detergent and then rinsed well with water. Thus, the cleaning process can be quite laborious depending on the extent of the efflorescence. Furthermore, if the source of the water penetration is not addressed, efflorescence may reappear. Generally, tradespersons will have a tendency to throw away tiles received from a manufacturer which exhibit any signs of efflorescence as a preventive measure for the discoloration not being able to be removed or reoccurring at a later date.

Primary factors affecting efflorescence include cement content, mix water, water/cement ratio, admixtures, curing conditions, and permeability. Greater cement content tends to increase the potential for efflorescence.

Mix water may contain various levels of calcium, magnesium, potassium, or sodium contributing to efflorescence potential. Especially conducive to efflorescence is water softened by ion exchange, during which each calcium and magnesium ion is replaced with two (more water-soluble) sodium ions.

Water/cement ratio is another significant factor, as increasing the water/cement ratio leads to a more porous concrete matrix, which increases the potential for efflorescence by adding excessive water and creating easier pathways.

Plasticizing admixtures have been shown to help optimize cement content and water/cement ratios in manufactured concrete products.

Permeability is also tied to efflorescence, the less permeable the concrete matrix, the lower the efflorescence potential. It is possible to protect cementitious products against efflorescence by treating the material with an impregnating, hydro-phobic sealer. The sealer is generally one which will repel water and penetrate deeply enough into the material to keep water and dissolved salts well away from the surface. Water-repellent (pore-blocking) admixtures have been shown to decrease permeability by repelling water and reducing wicking potential (absorption) of concrete units. The penetrating sealers allow the water vapour to “breathe” out but stop the salt molecules from migrating out. However, in climates where freezing is a concern, such a sealer may lead to damage from freeze/thaw cycles.

Proper curing of concrete products is essential for cement hydration and strength development. Typically, steam is used to provide high humidity and temperature for accelerated curing cycles. In some cases, carbon dioxide is forced into the concrete matrix. In theory, this is to form efflorescence below the surface and block pathways for further efflorescence on the outermost layer. This process, however, can be difficult to control due to such factors as varying product densities, absorption rates, moisture contents, air circulation, and humidity levels.

Careful curing in a factory can assist in minimizing efflorescence. However, during the processing of the slabs, a large quantity of water is used and this water can bring the calcium hydroxide to the surface where it can react with carbon dioxide in the atmosphere and effloresce. It is then necessary to clean off the efflorescence. Also, during transportation, varying degrees of efflorescence staining will most likely occur. This is the case where containerised shipping is used during transportation as the material is subject to extreme temperatures and temperature variations. Furthermore, when using containerized shipping, condensation may be present or heat may draw moisture from the material or surrounding materials so as to create an environment which encourages efflorescent staining.

Sometimes the efflorescent staining may be minor. However, even a small amount of efflorescent staining may be sufficient to adversely alter the true colour and/or intended finish of the material. Presently, it is common to retain the product in the factory as long as practical, prior to dispatching the product, in order to minimize this problem. It is also a common requirement to instruct customers how to store the material satisfactorily to minimize conditions under which efflorescence may occur.

Most concrete paver manufacturers have attempted to control the problem of efflorescence by using an admixture in their products. However, no manufacturer has completely eliminated the problem. Therefore, most contractors resort to the use of commercial efflorescence cleaners. Most cleaners will effectively reduce the whitish haze on the paver caused by efflorescence, but only if used properly. Many of these products are based on a mix of detergents and acids that ‘eat’ or ‘dissolve’ the insoluble carbonate and allow them to be washed away. However, some acids may also react adversely with pigments used to colour concretes and can result in alarming colour changes. Further, they can actually exacerbate the problem by un-plugging the blocked capillaries and micro-pores which then allows the Calcium Hydroxide to find its way to the surface once again. Further, application of these cleaners can be quite laborious and time-consuming.

Present packaging techniques include covering an entire palate of tiles or slabs with polystyrene sheets in order to prevent the tiles or slabs from reacting with elements in the atmosphere.

Efflorescence is highly undesirable as the unsightly staining causes concerns to customers. The customers may consider efflorescence to be a defect in the product and may also require detailed instructions to clean efflorescence staining from the product.

It is an object of the present invention to provide at least ameliorate one or more of the above-mentioned disadvantages associated with cementitious slab and tile production.

The reference to any prior art or prior art techniques, in this specification is not, and should not be taken as, an acknowledgement or any suggestion that these references form part of the common general knowledge of persons skilled in the relevant field of technology of the invention as claimed herein.

### SUMMARY OF THE INVENTION

In one aspect, the present invention provides a method of processing cementitious products including applying a protective layer to at least one surface of a slab product at the time of pouring cementitious mix into a mould and retaining the protective layer in place.

In an embodiment, the protective layer is a mould liner. The protective layer is applied to a surface of the mould prior to pouring material for the slab product. The protective layer is a relatively thin sheet of plastic material.

In an embodiment, the protective layer is applied to the surface of the mould before pouring mixture into the mould and is firmly fitted to the mould surface with a device to reduce the likelihood of air being entrapped between the mould surface and the protective layer.

In an embodiment, the protective layer is cut at the time the slab product is cut and thus the protective layer remains attached to the slab product subsequent to de-moulding.

In another embodiment, once the slab product is de-moulded, the slab product with the protective layer attached is inserted into a sealable container that is either evacuated or has a proportion of the air in the container replaced with another fluid prior to sealing the container.

In another embodiment, the slab product is not removed from the mould and hence the protective layer remains attached to the slab product. The overhanging edges of the protective layer are wrapped around one or more side edges of the slab product. The overhanging edges of the liner are sealed together with a heat sealer or shrink wrap sealer or the like to prevent passage of air to/from the slab through the sealed protective layer.

In another aspect, the present invention provides a method of processing a slab product including inserting the slab product into a sealable container, evacuating substantially all of the air and sealing the container prior to the slab product becoming fully cured.

In an embodiment, the slab product is vacuum packed in a plastic bag.

In an embodiment, the slab product is vacuum packed using a vacuum sealer to remove the air from inside the plastic bag.

In a further embodiment, the slab product is vacuum packed using a chamber vacuum sealer to replace the air inside the plastic bag with a suitable gas for preventing efflorescence. The gas can be a heavy gas such as carbon dioxide.

In a further embodiment, where a mould liner is used, the slab product is de-moulded and the mould liner is retained in place in the mould. The slab product is then inserted into a package that is subsequently sealed to prevent, or substantially reduce, the passage of air and/or moisture through the seal.

In yet another aspect, the present invention provides a method of processing a slab product including inserting the slab product into a sealable container and replacing substantially all of the air with another fluid or substance prior to sealing the container.

It will be recognised that the term “cure” is interchangeable with the term “set”. It will also be recognized that the term “semi-set” has a substantially similar meaning to “semi-plastic” or “semi-hardened”.

### BRIEF DESCRIPTION OF THE DRAWINGS

FIG. 1 is a diagrammatic illustration of a mixing vessel containing the component parts of a mixture prior to the mixing process;

FIG. 2 is a diagrammatic illustration of a mould substrate and a mould liner prior to fitting;

FIG. 3 is a diagrammatic illustration of a mould substrate and a mould liner during the fitting of same;

FIG. 4 is a diagrammatic illustration of the application of mould retaining walls to a substrate to which a mould liner has been fitted;

FIG. 5 is a diagrammatic illustration of pouring a mixture into a mould;

FIG. 6 is a diagrammatic illustration of a slab of material in a mould in a semi-set state during a cutting process;

FIG. 7 is a diagrammatic illustration of the slab products resulting from the cutting process illustrated in FIG. 6 with the mould retaining walls removed and the slab products de-moulded;

FIGS. 8A and 8B illustrate respectively the representative appearance of a prior art slab of material at a cut edge and a slab of material according to an embodiment of the invention;

FIGS. 9A and 9B diagrammatically illustrate de-moulded slab products with the mould lining removed and retained fitted to the slab product respectively;

FIGS. 10A and 10B diagrammatically illustrate a protective layer being applied to at least one surface of the slab product; and

FIG. 11 is a diagrammatic illustration of the slab product vacuum packaged within a plastic bag.

### DETAILED DESCRIPTION OF EMBODIMENTS OF THE INVENTION

It should be noted that all of the discussion below, regardless of the particular embodiment being described, is exemplary in nature, rather than limiting.

The present invention is relevant to the packaging of cementitious slabs and/or tiles produced therefrom, which may be used for tiles (internal, external, floor and wall; conventional and alternative type tiles); paving cladding for walls (both internally and externally) mosaics (including floor mosaics); kitchen bench tops; kitchen counters, benches and islands; table tops; integrally cast products for tilt-up panels, including scoff systems; curtain walling and external cladding with optional accessories, including products containing fibre; insulation tiles; other slab products for the slab market; furniture; roof tiles or slab and/or tiles for other suitable applications.

An example method for producing a cementitious slab according to the present invention includes steps of mixing cement, a fine aggregate material, an ultra fine aggregate material and water.

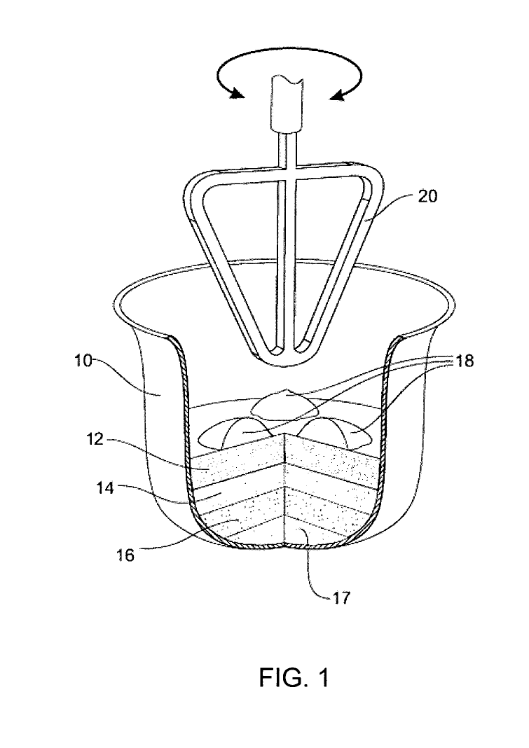

With reference to FIG. 1, a mixing vessel (10) is illustrated containing materials such as cement (12), fine aggregate (14) an ultra-fine aggregate (16) and a crushed or ground (flour) material (17). In the exemplary embodiment of FIG. 1, the mixing vessel (10) is also illustrated containing three mounds of pigment (18) that are included in the mix to achieve the desired colour of the resulting slab of material.

The fine aggregate material (14) and/or the ultra fine aggregate material (16) may be a siliceous material, including sand. Further, the cementitious mix may also include a crushed or ground aggregate material (flour) (17), wherein the crushed aggregate material may also be sand.

In order to reduce water content of the cementitious mix, a water reducing plasticizer may be added, which may be a polycarboxylic ether polymer. The amount of water reducing plasticizer may be between approximately 1% to 5% of the mix by weight of cement. For example, should the cement content of the cementitious mix be 100 kilograms, the amount of water reducing plasticizer may be between approximately 1 kilogram and 5 kilograms. The water to cement ratio, where a water reducing plasticizer is used, may be approximately 0.24-0.26.

The ratio of cement (12) to fine aggregate material (14) to ultra fine aggregate material (16) may be 2:2:1. For example, the cementitious mix may contain 100 kilograms of cement, 100 kilograms of fine aggregate material and 50 kilograms of ultra fine aggregate material. Furthermore, in an embodiment where the cementitious mix includes either crushed aggregate material or flour, the ratio of cement to fine aggregate material to ultra fine aggregate material to crushed sand or flour may be 10:10:5:2. For example, the cementitious mix may contain 100 kilograms of cement, 100 kilograms of fine aggregate material, 50 kilograms of ultra fine aggregate material and 20 kilograms of crushed aggregate material or flour.

Of course, the precise ratios of materials in any mix that will produce the best result will depend upon the quality and suitability of the materials, the quality of any polycarboxylate admixture and the efficiency of the mixing apparatus.

In a further embodiment, a buffer solution is added to the cementitious mix to reduce surface tension such as vinegar and/or ethanol, which is included in order to reduce air content of the cementitious mix. The air content of the cementitious mix is generally in the form of air bubbles and it is intended for the vinegar and/or ethanol to reduce the air bubble content of the cementitious mix. The vinegar and/or alcohol to cement ratio may be approximately 0.075.

The cementitious mix may be mixed in a standard commercial dough mixer including a mixing vessel (10) and a mixing head (20) until thoroughly mixed into a wet consistency. The period of mixing may be approximately 3 to 5 minutes.

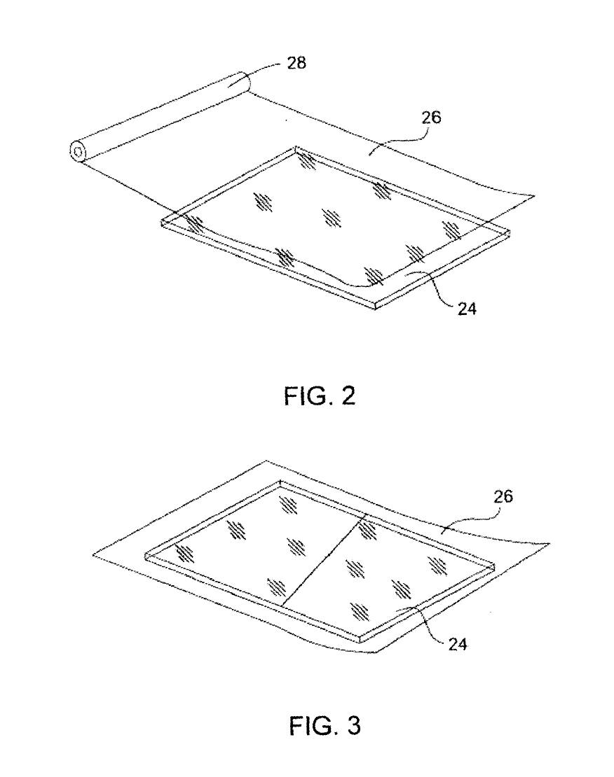

With reference to FIG. 2, a mould substrate (24) is provided in the form of a sheet of glass. A suitably sized sheet of mould liner (26) is removed from a roll of the liner material (28) and placed over the mould substrate (24). The liner (26) is then applied to the top surface of the mould substrate (24) as illustrated in FIG. 3. The liner (26) is applied to the substrate (24) firmly in order to prevent, or at least minimize, the possibility of air being trapped between the liner (26) and the mould substrate (24)

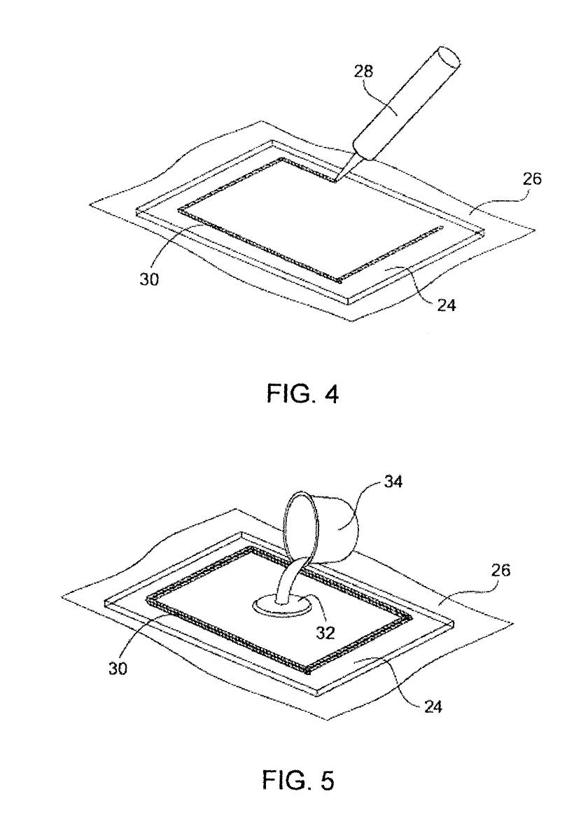

Once the mould liner (26) is applied to the mould substrate (24), an acrylic material is dispensed from a tubular container (28) to form a mould retaining wall (30) (refer FIG. 4). The height of the mould retaining wall (30) will depend upon the required depth of the slab. With reference to FIG. 5, slab material (32) is poured into the mould from a mixing vessel (34).

Moulds may be of varying shapes and sizes and may be made from various materials including aluminium, steel, timber, plastic, glass and/or acrylic etc.

The mould lining assists in preventing damage to the mould by the cutting tool and may be discarded and replaced after the de-moulding process. The mould liner may be formed from plastic, waxed paper or any material suitable for this process.

When in the mould, the cementitious mix is allowed to substantially self-level. The self-leveling process may require approximately 2 minutes to 6 minutes in duration. Further, during self-leveling, air and air bubbles escape from the cementitious mix. Approximately 80% to 95% or greater of air and air bubbles are expected to escape from the mix during the self-leveling process without intervention.

A further reduction in air and air bubbles may be achieved by gently vibrating the mould containing the cementitious mix. A cementitious mix may be vibrated until air and air bubbles substantially no longer appear to be escaping the surface of the cementitious mix. In this regard, the gentle vibration may be of approximately 3 to 10 seconds duration.

Following leveling and vibrating of the cementitious mix, it is allowed to set until it is in a substantially semi-set (or substantially semi-hardened) state. When in a semi-set state, the cementitious material or cementitious slab is cut in to tiles or other desired products. As it is in a semi-set state, the cementitious material may be cut with a knife or other sharp cutting tool vibrated at a preselected frequency.

The preselected frequency may be an ultrasonic frequency, which may be in the range of 20 kHz to 40 kHz. The ultrasonic cutting tool may be a hand held type or may be incorporated into automated machinery, such as computer controlled automated cutting machinery.

It will be appreciated that an embodiment using a blade vibrating at an ultrasonic frequency should result in very little or substantially no cementitious material adhering to the blade when cutting. This should result in the blade not requiring cleaning and should also result in little or substantially no cementitious material being removed from the slab during the cutting process.

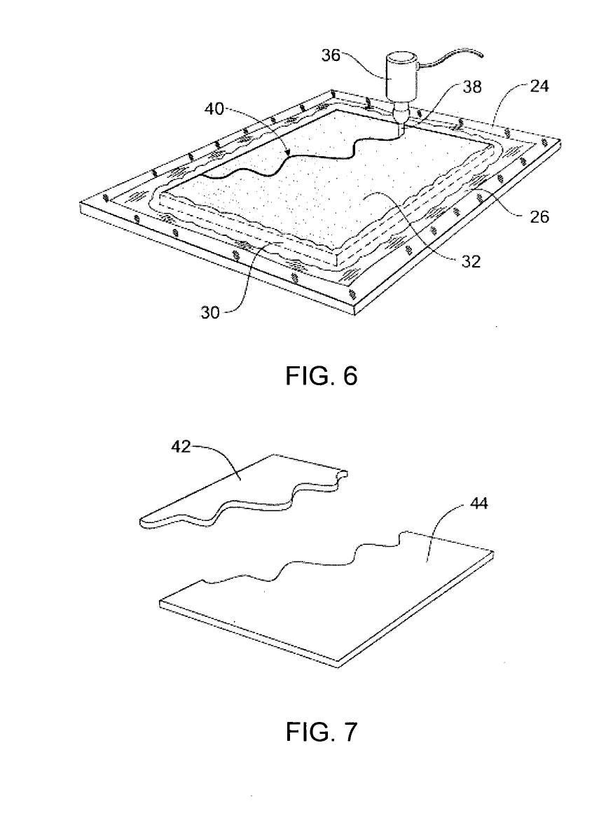

With reference to FIG. 6, a diagrammatic illustration of the cutting process is provided wherein the slab material (32) has cured to a semi-set state and a cutting device (36) controlled by a robotic arm passes a vibrating cutting tool (38) through the slab material (32). A path 40 is cut through the slab material (32).

With reference to FIG. 7, a diagrammatic illustration of the slab products (42, 44) resulting from the cut 40 through the slab of material is provided. Further, in FIG. 7, the mould retaining walls (30) have been removed and this can be effected by trimming the mould retaining walls (30) off the slab. In this regard, selecting a material for the mould retaining wall (30) that is sufficiently malleable allows same to be cut by the vibrating cutting tool (38).

The ultrasonic cutting tool (38) may be a thin blade, capable of cutting but substantially not removing cementitious material from the slab. Further, cutting of the material may occur at a rate of approximately 300 to 800 mm per second.

It should be understood that, when the cementitious slab is in a semi-set state, other cutting techniques may be employed as an alternative to ultrasonic cutting.

The cementitious material may cure into a substantially semi-set state following self-leveling and/or vibration. This part of the curing process may be approximately 30 minutes to 1 hour in an ambient temperature of approximately 21 degrees Celsius. A higher ambient temperature may accelerate the curing time. It is important to understand that cutting of the cementitious slab may occur at any time after the placement of the cementitious material into a mould, however, the cementitious material should be leveled and, air allowed to escape or be removed with further time allowed for the cementitious material to sufficiently cure so as to be in a semi-set state.

The cementitious material may be assessed for suitability for cutting by applying the cutter to the cementitious material and observing that when the material is cut it substantially does not move and/or meld back together around the cut.

It will be recognised that, as the cementitious slab is cut whilst in a substantially semi-set state, there is substantially reduced stress on the cementitious material as compared with previous methods of cutting where a cementitious slab is in a substantially hardened state. Accordingly, due to reduced stress on the cementitious material, chipping and breaking of the cementitious slab should be substantially reduced or eliminated. Further, little or substantially no cementitious material is removed from the cementitious slab during the cutting process of the present invention.

The cementitious slab may be cut into tiles having a range of sizes and shapes. The shapes may include curved and rounded shapes and the tiles may also be produced with sharp corners. Further, cutting a cementitious slab whilst in a semi-set state does not require the use of expensive cutting equipment, such as diamond tools, and reduces cutting time. Also, the amount of water required for cutting is substantially reduced or may be eliminated altogether. This has a further advantage in that little or no effluence is produced, which previously required expensive treatment and/or disposal.

The method of the present invention may be used to prepare a slab material from which it is possible to cut shapes, angles and sizes which have previously been considered as either not possible or too problematic.

As the process does not require high pressure water during cutting and calibrating, stress imparted upon the slab is substantially reduced, which in turn reduces damage. This allows the slab to be cut into pieces with a reduced thickness.

The cementitious slab may be cut to thicknesses of between approximately 3 mm to 5 mm which may create possibilities for new and innovative products.

Furthermore, as a result of there being less stress caused to the product during processing, the material may be substantially stronger. In turn, this may result in fewer problems, such as broken corners etc, during installation of the product.

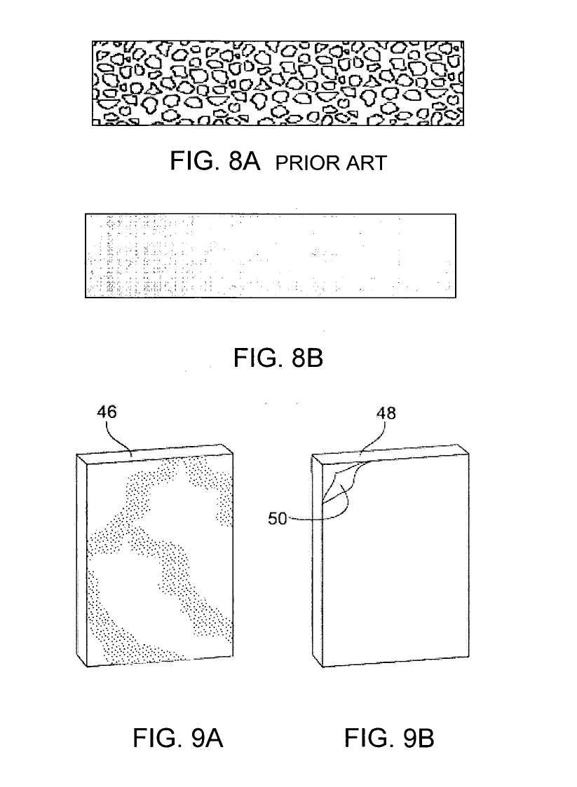

Moreover, as no large aggregate pieces are used in producing the cementitious material, there may be a reduction in post-installation issues associated with the slow development cracks (including hair-line cracks). It is expected that slab products produced according to the present invention will provide a more pleasant aesthetic appearance along cut edges as compared with previous products that included large aggregate in the mix. With reference to FIG. 8A, an example profile of a cut edge of a slab product according to present production methods is illustrated in which the size and shape of the large aggregate dominates the appearance. In contrast, FIG. 8B illustrates an example profile of a cut edge of a slab product according to the present invention which is expected to be more widely acceptable for use in instances where the cut edge will be visible.

The cementitious slab may also be assessed and/or calibrated for consistency of thickness whilst in a semi-set state. Any areas of the cementitious slab which are thicker (higher) than desired may be removed. Removal may be effected by a cheese grater type device. However, it will be recognised that any requirement for assessing and/or calibrating the thickness of the cementitious slab and/or removing material from thicker areas of the slab should be substantially reduced or eliminated due to the method of production of the slab according to the present invention.

Assessing and/or calibrating the thickness and/or removing cementitious material in order to achieve an even thickness may occur before the slab is cut or after the slab is cut into tiles. However, calibration and/or assessing and/or removing cementitious material should occur whilst the cementitious slab is in a semi-hardened (semi-set) state.

Following cutting of the cementitious slab, the tiles are stored for approximately 20 to 24 hours, which allows for further hardening of the tiles. The tiles are hardened such that they may be taken from the mould.

The de-moulded tiles are then packaged and allowed to completely cure.

With reference to FIGS. 9A and 9B, de-moulded slab products are illustrated. In the instance of FIG. 9A, the mould liner has been removed from the slab product (46). This may occur at the time of de-moulding where the slab product (46) is removed whilst the liner is retained in place. Alternatively, as illustrated in FIG. 9B, the mould liner is cut at the time the slab product is cut and thus the liner (50) remains attached to the slab product (48) subsequent to de-moulding. The liner (50) may then be removed from the slab product (48) or retained in place to protect the slab product (48) during subsequent handling and transport.

The de-moulded slab products are then packaged and allowed to completely cure. The complete curing allows the cementitious material of the tiles to achieve full strength whilst in the packaging. The packaged product may then be transported and/or delivered whilst curing. This reduces or eliminates the need for curing the product whilst in a factory. Furthermore, efflorescence staining may be substantially reduced or eliminated.

When the liner (50) is retained on the slab product (48) it acts as a protective layer for the top surface of the slab product (48) until the product has completely cured. During the cement hydration process which occurs until the slab product (48) is completely cured, calcium hydroxide is present in a liquid state. The liner (50) provides a barrier at the top surface of the slab product (48) to ensure that the calcium hydroxide is not exposed to and cannot react with carbon dioxide in the air to form calcium carbonate. Thus, preventing primary efflorescence occurring on the surface to which the liner is applied.

It is intended that the top surface will be the surface which is visible once the slab product (48) has been laid. While efflorescence may still occur on the unprotected bottom surface and/or side edges, this will not be visible once the product has been laid and therefore will not affect the aesthetic appeal of the product as installed. It is envisaged that once the liner (50) has been removed and the slab product (48) has been installed, a suitable sealer can be applied to the top surface of the slab product (48) to prevent secondary efflorescence, if necessary.

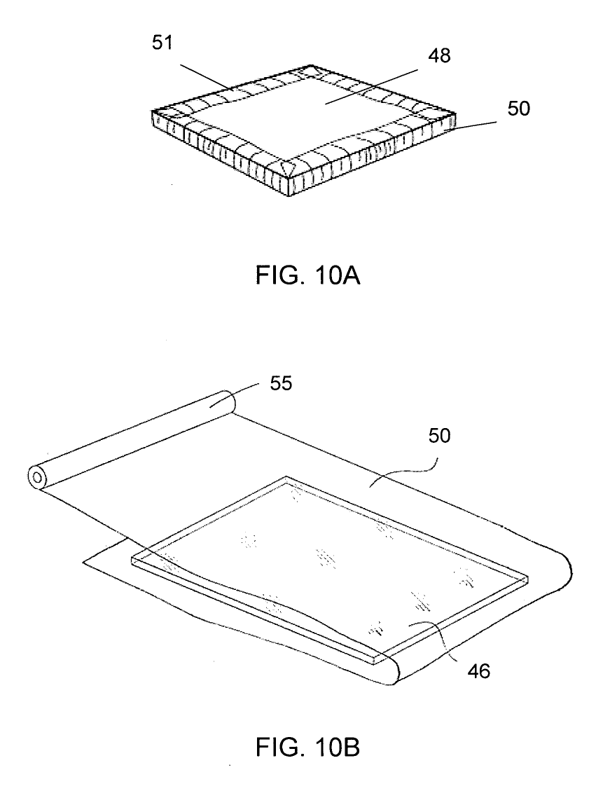

With reference to FIG. 10A, an example is illustrated where the liner (50) which has remained attached to an uncut slab product (48) is used to package the product for transportation and/or storage. A piece of liner (50) larger than the size of an uncut slab product (48) is placed on the bottom surface of the slab. The overhanging edges (51) of the liner (50) are then wrapped around the edges of the slab product (48) such that the overhanging edges (51) will wrap around the sides edges onto the top surface of the slab. The overhanging edges (51) can be secured in place via heat shrink wrapping, heat sealing or any other suitable means.

An alternative application of the liner (50) for packaging the slab product (48) is illustrated in FIG. 10B. In the instance of FIG. 10B, the mould liner has been removed from the slab product (46) at the time of de-moulding where the slab product (46) is removed whilst the liner is retained in place. The liner (50) can be applied to both the top and bottom surfaces of the slab product (46). A suitably sized sheet of liner (50) is removed from a roll of the liner material (55) and placed over the top and bottom surfaces of the slab product (46). The liner (50) is then heat sealed along the open side edges to package the slab product (46) within the liner material (50). This application of the liner (50) ensures that all surfaces of the slab product (46) are protected from primary efflorescence. A suitable sealer can then be applied to the top surface of the slab product (46) once the product has been installed to prevent, or at least substantially reduce, secondary efflorescence.

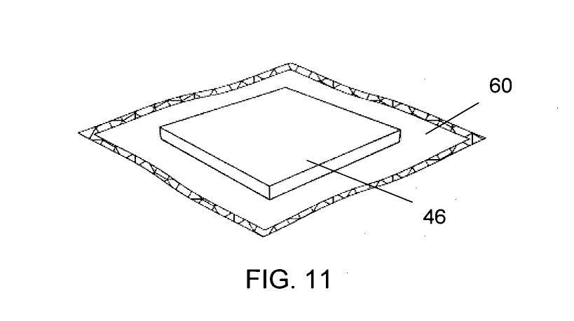

In a further embodiment, uncut and cut slab products which have had the liner (50) removed during the de-moulding process are vacuum packed in a sealable container. According to some embodiments, a plastic bag is used to vacuum pack the slab products, as illustrated in FIG. 11. The plastic bag (60) is suitably sized to package one or more slab products (46) therein. Preferably, the slab products (46) are individually packaged to prevent marking on the slab products (46) arising as a result of two or more slab products (46) rubbing against each other.

The slab product (46) is placed inside the plastic bag (60) and the plastic bag (60) is then vacuum sealed to substantially remove all of the air from inside the bag. Removal of the air and moisture immediately surrounding the surface of the cementitious slab product (46) substantially minimises the likelihood of efflorescence occurring.

The present invention provides a controlled environment for pre-delivery storage to ensure optimal conditions that reduce formation of excessive condensation which returns water to the slab product (46) and so promotes migration. This is mainly achieved by keeping the newly manufactured slab products in an environment that prevents, or at least substantially minimises, any condensation. Moisture in the slab material cannot escape therefore providing an environment which reduces efflorescence and maximises effective curing.

In another embodiment, the plastic bag (60) is sealed using a chamber vacuum sealer. In this embodiment, it is envisaged that the slab product will have the liner (50) attached to one or more surfaces of the slab product (46). The chamber vacuum sealer removes the air from inside the plastic bag (60) and replaces the air with another more desirable gas. The packaging can include replacing air in the packaging with a heavy gas, for example, carbon dioxide.

Carbon dioxide, introduced under pressure and in the absence of oxygen, may have an advantage in that it reacts with liquid calcium hydroxide in the cementitious material to produce solid calcium carbonate. The addition of carbon dioxide acts to reduce efflorescence through the process of “capillary blocking” whereby the tiny pores and voids within the concrete matrix through which the soluble Calcium Hydroxide is transported eventually become plugged with deposits of the insoluble Calcium Carbonate. Packaging the tiles in this manner may cause any efflorescence to occur below the surface of a tile where it will not be apparent by effectively blocking the escape route for the Calcium Hydroxide and ‘locking in’ any further reactions, forcing them to take place below the surface. Thus, reducing or eliminating the problem of aesthetically displeasing surface efflorescence.

In a further embodiment, when packaging the tiles, the process may include the application of a fluid or other suitable substrate. According to some embodiments, a sodium metasilicate or a potassium metasilicate substrate mist is applied to the surface of the product prior to packaging or whilst being packaged using any one of the various methods described herein. The addition of sodium silicate/potassium silicate also acts to reduce efflorescence through the process of “capillary blocking” by reacting with free calcium hydroxide to form a calcium silicate. ‘Filling” the capillaries and pores blocks the migration of water to the surface and thus, reduces efflorescence occurring on the surface. The calcium silicate may provide a harder and less chemically sensitive substance than calcium carbonate.

This reaction may also occur subsurface. The packaging process may include introducing a heavy gas and a sodium and/or potassium silicate vapor into the vacuum package.

The present invention embodies various advantages. Minimising efflorescence during the production, curing, storage and transportation stages enables the slab products to be delivered on site ready for immediate installation without requiring cleaning prior to use. Further, the processing of slab products according to the present invention enables the slab products to continue to cure whilst in transit and hence avoids the requirement to store the products in a controlled environment in an attempt to avoid efflorescence or water staining. Maintenance of the slab products in good condition ensures the tradesperson or consumer will not refuse the product based on its appearance and thus, results in less wastage and cost as a result of products been discarded unnecessarily. Obviating the need to store the slab products whilst they are curing also reduces costs associated with floor space for storage.

Prevention is better than cure, both in cost terms and in those situations where repeated remedial treatment is needed for new appearances of efflorescence. The accumulated effects of the latter cycles might give rise to some longer term structural damage in certain instances.

While certain exemplary embodiments have been described, it is to be understood that such embodiments are merely illustrative of and not restrictive on the invention, and that this invention is not limited to the specific constructions and arrangements described since various other changes, combinations, omissions, modifications and substitutions, in addition to those set forth in the above paragraphs, are possible. Those skilled in the art will appreciate that various adaptations and modifications of the described embodiments can be configured without departing from the scope and spirit of the invention. Therefore, it is to be understood that, within the scope of the appended claims, the invention may be practiced other than as specifically described herein.

1. A method of processing cementitious products comprising applying a protective layer to at least one surface of a slab product at the time of pouring cementitious mix into a mould; and retaining the protective layer in place.

2. A method according to claim 1, wherein the protective layer is a liner.

3. A method according to claim 1, wherein the protective layer is applied to a surface of the mould prior to pouring material for the slab product.

4. A method according to claim 1 wherein the protective layer is a relatively thin sheet of plastic material.

5. A method according to claim 3, wherein the protective layer is applied to the surface of the mould with a device to reduce the likelihood of air being entrapped between a mould surface and the protective layer.

6. A method according to claim 1 wherein the protective layer is cut at the time the slab product is cut and thus the protective layer remains attached to the slab product subsequent to de-moulding.

7. A method according to claim 1 wherein the overhanging edges of the protective layer are wrapped around one or more side edges of the slab product.

8. A method according to claim 7, wherein the overhanging edges of the protective layer are sealed by the application of heat.

9. A method according to claim 1 wherein a suitably sized sheet of the protective layer is removed from a roll of liner material and placed over a top surface and a bottom surface of the slab product and heat sealed along the open side edges to enclose the slab product.

10. A method of processing a slab product comprising inserting the slab product into a sealable container; and evacuating substantially all of the air and sealing the container prior to the slab product becoming fully cured.

11. A method according to claim 10, wherein the slab product is vacuum packed in a plastic bag.

12. A method according to claim 10, wherein the slab product is vacuum packed using a vacuum sealer to substantially remove all the air from inside the sealable container.

13. A method according to claim 10, wherein the slab product is vacuum packed using a chamber vacuum sealer to substantially replace all the air inside the sealable container with a gas.

14. A method according to claim 13, wherein the gas is a heavy gas.

15. A method according to claim 13, wherein the gas is carbon dioxide.

16. A method according to claim 10, wherein the slab product is vacuum packed using a chamber vacuum sealer to substantially replace all the air inside the sealable container with another fluid or substrate prior to sealing the container.

17. A method according to claim 16, wherein a sodium metasilicate or a potassium metasilicate substrate is applied to the surface of the product prior to packaging or whilst being vacuum packaged.

18. A slab product formed by applying a protective layer to at least one surface of the slab product at the time of pouring cementitious mix into a mould; and retaining the protective layer in place.

19. A slab product formed by inserting the slab product into a sealable container; and evacuating substantially all of the air and sealing the container prior to the slab product becoming fully cured.
